(19) United States
(12) Patent Application Publication
(10) Pub. No.: US 2001/0056493 A1
(43) Pub. Date: Dec. 27, 2001

(54) Server assignment device, service providing system and service providing method

(76) Inventor: Akira Mineo, Sagamihara (JP)

Correspondence Address: Mattingly, Stanger & Malur, P.C., 104 East Hume Avenue, Alexandria, VA, 22301, US

(21) Appl. No.: 09/808,948

(22) Filed: Mar. 16, 2001

(30) Foreign Application Priority Data
Jun. 27, 2000 (JP) 2000-197859

(51) Int. Cl. G06F 15/16; G06F 17/60

(52) U.S. Cl. 709/227; 705/26; 709/245; 705/14

(57) ABSTRACT

Since in a conventional service providing system including shopping service systems, the service servers are selected by the service users so that the service condition cannot be configurable such that certain specific users are eligible to connect to high quality, high performance service servers while other users are not. In accordance with the present invention, in a service providing system including shopping service systems, a facility is provided for selecting one of service servers of different service contents on the basis of the user records of service users.

### BACKGROUND OF THE INVENTION

1. Field of the Invention

The present invention relates to a technology in a field of information communication service systems and more particularly to a technology, which connects each service user to an appropriate service providing server.

2. Description of the Prior Art

When a service provider implements a service using a plurality of service providing servers, a list of server groups each providing a service category (including mirror servers that store the same contents, in order to distributing loads) has been displayed on a browser window of the user so as to allow each user to select an appropriate server. In addition, link information relating to the fields of interest of the service users (address information for pointing to the home page addresses or the location of information of interest) has been displayed on a browser window of the user, provided in accordance with the user attributes at the time of registration, such as gender, age, hobby, preference, and the like. In recent years, banners (a sort of advertisements displayed on a browsing window in a form of belt or band, which often includes links) which may have a relation to the keyword specified in a keyword search are displayed on the browser to allow users to click thereon to select a server. Related examples of known disclosures may include Japanese Unexamined Patent Publication No. Hei 10-134080, No. Hei 10-307845, and No. Hei 11-212999.

Service providers of internet shopping and the like may need a special function to implement in their service servers for providing services, in order to increase the profit by providing sophisticated services convenient for their users. For instance, the provider may need a service server to be equipped with a high performance processor, which enables a quick response from the server for a pleasant shopping, a large capacity and/or high speed hard disk drive (HDD) for storing high definition images of their products, audio data for explaining the products, and music contents, a video server for distributing description of products and movie contents, a VOIP (Voice Over IP) adaptor which encapsulates voice data in the IP (Internet Protocol) packets to allow service customers to directly talk with a sale person, a teacher, a doctor, a specialist, a knowledgeable people, and so on, a high performance database (DB) for quick search of products and purchase processing, and a high performance inference engine which may perform a sophisticated inference for the advisory of stock exchange, and the like. The service provider of internet commerce including shopping has to be capable of suitably connecting and allocating service customers to the service servers providing such sophisticated services. In this context the term“shopping service” refers to as a service category that provides for example valuable products or services and information in either a tangible form or not.

In the prior technology as have been described above, users need to point out the address information including URL (Uniform Resource Locator), or users need to select a home page or a server on the basis of link information displayed on the user terminal. This indicates that the selection of a service server is relied upon the choice of users. In the prior technology as described above, in addition, a service server is selected according to the link information generated based on the user attribute and search keyword. Thus it is difficult to allocate only specific users who have purchased frequently (i.e., premium users) to a specific server that provides the sophisticated services as have been described above. Guest users who simply browse the products, member users who wish to purchase a product, member users who promise to purchase enough items (i.e., premium users) are all capable of connecting to a same high quality service server, without screening. This has resulted in a lowered sales profit from the shopping service system, due to the fact that the users who visit frequently and are promised to purchase many items (i.e., premium users) and the users who are likely to contribute to the purchase may have sometimes difficulty of connecting to the high quality servers of limited quantity or difficulty of conveniently and comfortably receiving the pleasant service.

### SUMMARY OF THE INVENTION

The present invention has been made in view of the above circumstances and has an object to provide an informative communication service system which allows each of service users to connect to one of appropriate service servers expected to be effective in increasing sales profit, based on the purchase records of users in a manner suitable for increasing sales profit.

To achieve the above object and in accordance with the purpose of the invention, as embodied and broadly described herein, the informative communication service system in accordance with the present invention comprises a facility or program for allocating or assigning users to either service servers each having a function built in to provide a sophisticated service, or service servers without the function to provide the sophisticated service, based on the purchase records of service users. The system in accordance with the present invention also comprises a function for generating incentive information displayed on the user terminal.

The above and further objects and novel features of the present invention will more fully appear from following detailed description when the same is read in connection with the accompanying drawings. It is to be expressly understood, however, the drawings are for the purpose of illustration only and not intended as a definition of the limits of the present invention.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention. In the drawings,

FIG. 1 is a schematic block diagram of a shopping service system in accordance with first preferred embodiment of the present invention;

FIG. 2 is a schematic diagram of an address input field used for the connection with the representative server;

FIG. 3 is a schematic diagram of a display screen-for selecting an option of member/guest/joining used in the connection to the representative server;

FIG. 4 is a schematic diagram of a confirmation display of membership used in the connection to the representative server;

FIG. 5 is a schematic diagram indicative of an incentive display screen displayed in accordance with the user's purchase records in the past;

FIG. 6 is a schematic diagram of a menu display of the shopping service for members;

FIG. 7 is a schematic diagram of an incentive display for inviting guests to join the system;

FIG. 8 is a schematic diagram of a shopping information displayed for the guests;

FIG. 9 is a schematic diagram of input fields for the membership application of a guest user;

FIG. 10 is a sequential chart indicative of transaction by a service user until a top page of the service will be displayed;

FIG. 11 is a sequential chart indicative of a shopping transaction by a member user;

FIG. 12 is a sequential chart indicative of a shopping transaction by a member user;

FIG. 13 is a sequential chart indicative of a shopping transaction by a guest user;

FIG. 14 is a sequential chart indicative of a transaction for a guest to join the system;

FIG. 15 is a schematic block diagram of the process by the representative server for generating an incentive information and the address of a service server;

FIG. 16 is an exemplary user record table for the representative server to determine the purchase record of a member user;

FIG. 17 is an exemplary user record/grade table for the representative server to determine the grade value based on the purchase record of a member user;

FIG. 18 is an exemplary member ID/grade value table storing a grade value for each member user;

FIG. 19 is an exemplary grade/incentive information table for the representative server to determine the incentive information from the grade value;

FIG. 20 is an exemplary grade/server address table for the representative server to determine the address of a service server based on the grade value of a member user;

FIG. 21 is a schematic diagram of service server groups having functions for implementing sophisticated services for the shopping service system;

FIG. 22 is a sequential chart for displaying the user information of a member to the consultant personnel of the service server when the ‘talk to us’ button is clicked;

FIG. 23 is a schematic block diagram of an exemplary shopping service system in accordance with second preferred embodiment of the present invention;

FIG. 24 is a sequential chart indicative of a request from a service user sent to a service server through an address resolver;

FIG. 25 is an exemplary table for the address resolver server to transfer a request from a service user to a service server on the basis of the IP address of the service user; and

FIG. 26 is a sequential chart indicative of a network address translation for the address of an address resolver in a request of a service user to be transferred to the service server.

### DETAILED DESCRIPTION OF THE PREFERRED EMBODIMENTS

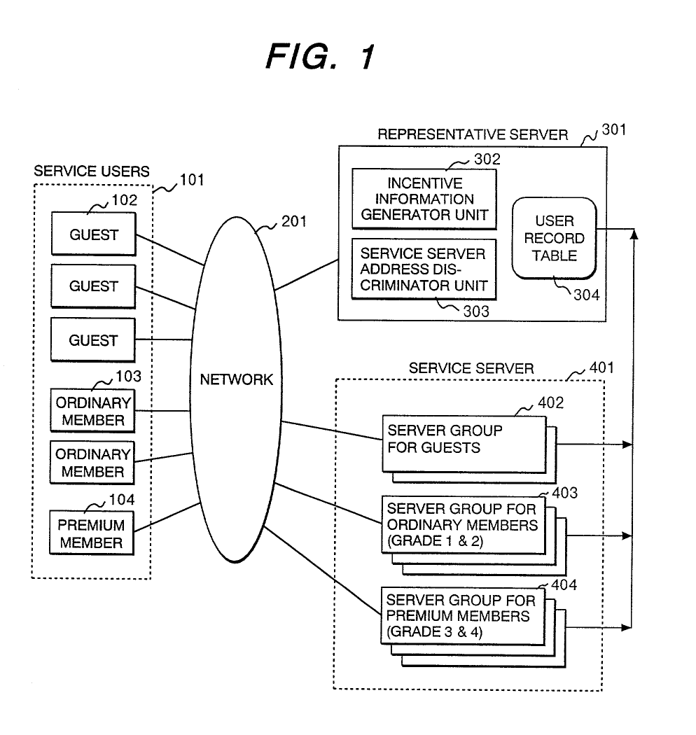

A detailed description of preferred embodiments embodying the present invention will now be given by way of example of a shopping service system by referring to the accompanying drawings of FIG. 1 to FIG. 26.

Now referring to FIG. 1, there is shown an overview of the entire shopping service system in accordance with the present invention. This system includes service users (terminals) 101, a service server 401 for providing shopping services, and a representative server 301 for determining the address of the service server 401.

The service users 101 are composed of guest users 102 who do not possess a membership of the service system, ordinary users 103 having a membership of the service system, and premium members 104 having a large quantity of records of purchase among users. The difference between a guest 102 and an ordinary member 103 or a premium member 104 is in that the guest is not registered to the shopping service system, i.e., does not provide any necessary information with respect to the identification including such as the name and address for a purchase order in the shopping service system, the bank account number or credit card number for the settlement, thus does not possess a unique membership ID number. The ordinary members 103 and premium members 104 may purchase any items from the service system. The purchase record of respective users is stored in a user record table, classified by the membership grades based on the purchase record such that a user may be offered with a variety of services in correspondence with the grade. In the preferred embodiment users are assigned to one of levels (grades) 1 to 4, however any number of grades can be used for classification.

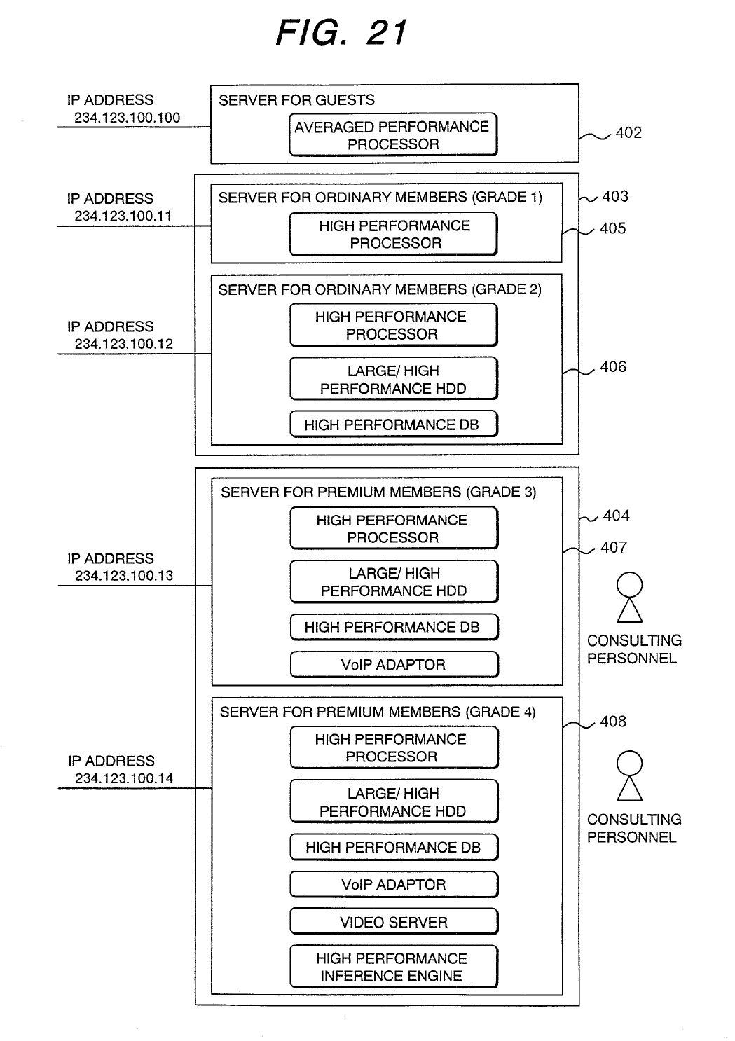

The service servers 401 are composed of a server group for guests 402, a server group for ordinary members 403, and a server group for premium members 404. An exemplary architecture of service servers 401 is shown in FIG. 21. The service servers 401 of the present embodiment includes, by way of example, a server for guests 402 only with an average performance processor, another server for ordinary members 405 with a high performance processor, another server for ordinary members 406 equipping a large and high performance HDD and a high performance DB in addition to the server 405, a server for premium members 407 additionally equipping a VoIP adaptor in addition to the functionality of the server 406, and another server for premium members 408 including furthermore a video server and a high performance inference engine in addition to the functionality of the server 407. Other configurations can be possible, for example a configuration in which the number of members simultaneously connected to one server is limited for the servers of the same performance, and the premium users are allocated to the server having the number of connections from limited members so as to achieve a similar effect to the case of using high performance servers.

The representative server 301 shown in FIG. 1 includes a user record table 304 for storing the records of services used by the users in the past, an incentive information generator unit 302 for sending a notice to users 101 of special bonus sale for inviting users for more purchase of products on the basis of the purchase records in the user record table 304, and a service server address discriminator unit 303 for dispatching each of server addresses of the service servers 401 on the basis of the user record table 304.

(1) Handling the Connections for Transaction

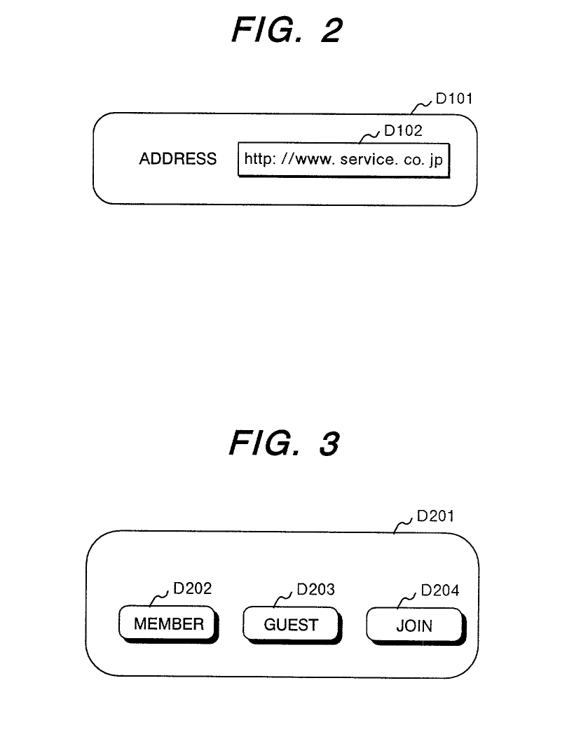

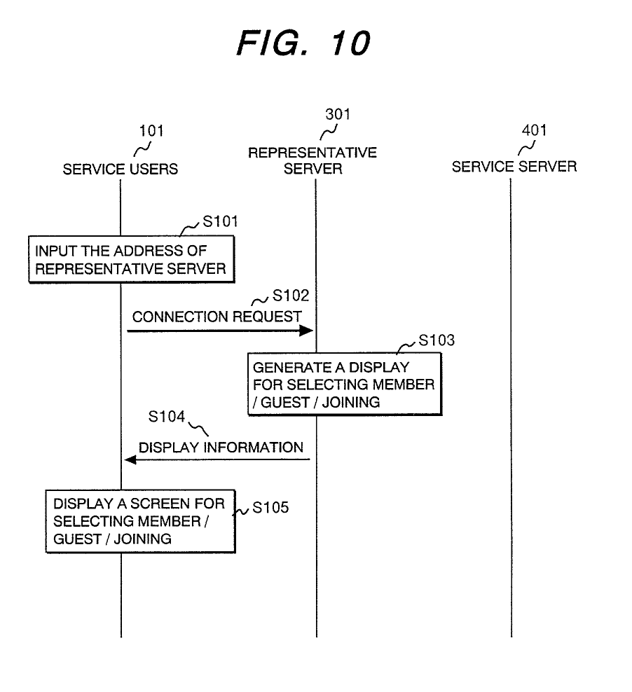

FIG. 10 shows how to handle the connections from the service users 101 to the representative server 301 at the beginning of use of the shopping service system. In this figure, the service user 101 includes the terminal used by the service users. At first, a service user 101 will input the address of the representative server 301 in the address input field D102 of a representative server address input window D101 as shown in FIG. 2 (step S101). With the address input, the terminal will be connected to the representative server 301 (step S102). The representative server 301 will generate information on a screen for selecting one of member/guest/joining options (step S103) to reply the display screen information to the service user 101. Then the selection screen D201 of member/guest/joining options as shown in FIG. 3 will be displayed to the service user 101 (step S105).

(2) Service provided to the members

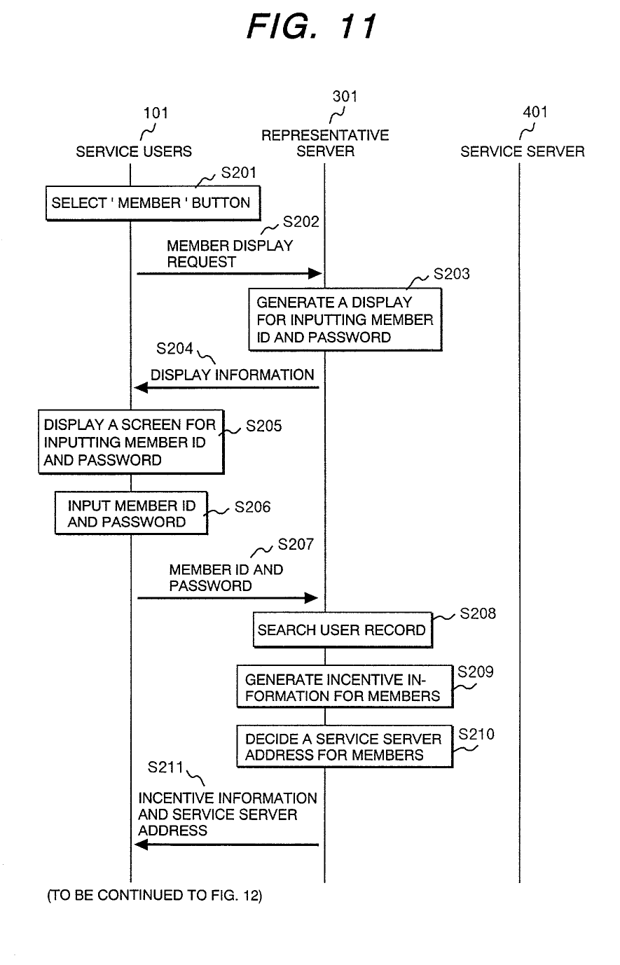

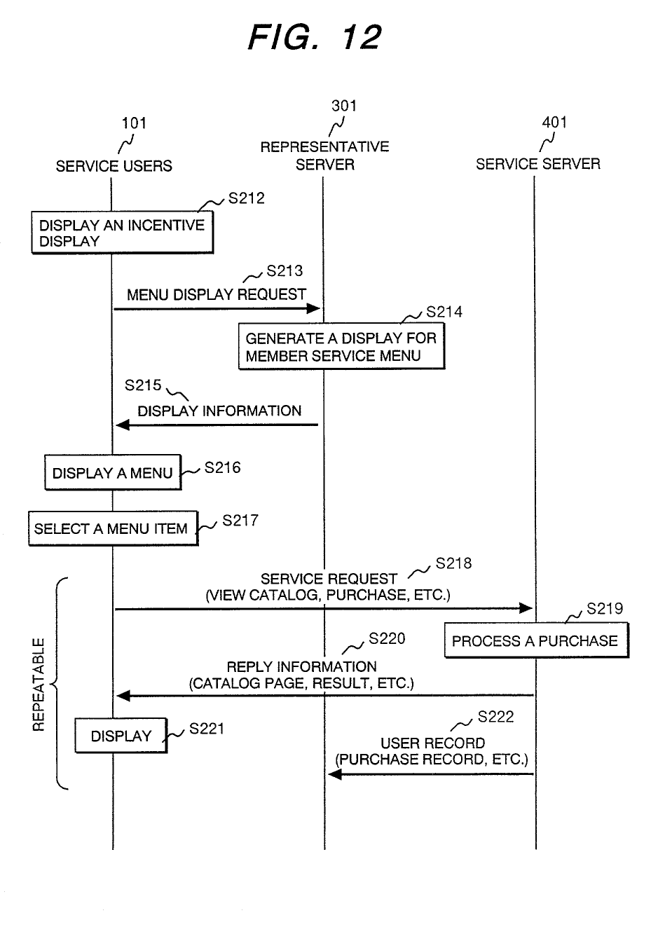

The flow of operation when clicking the member button D202 of the selecting screen D201 of FIG. 3 will be described by referring to FIG. 11 and FIG. 12.

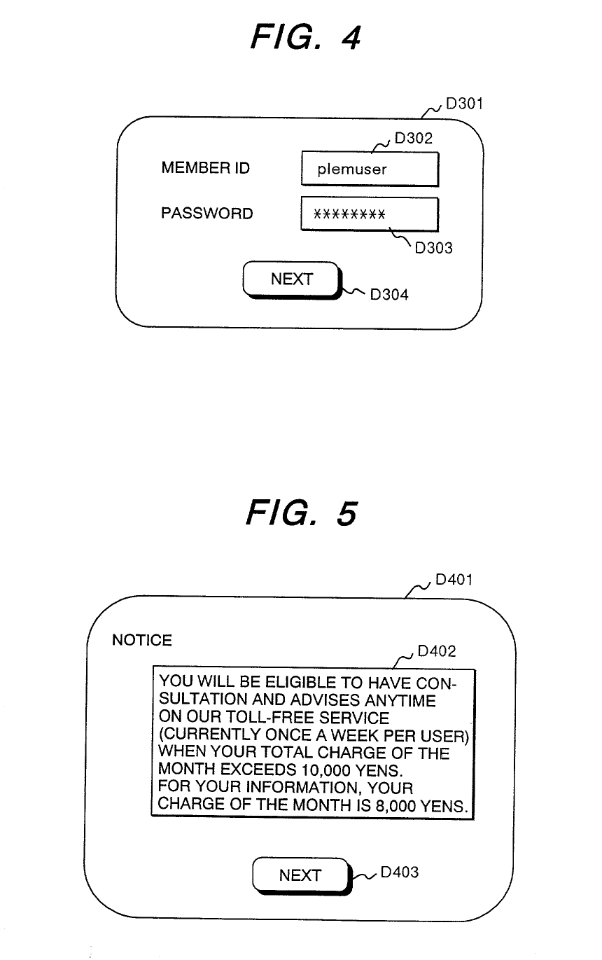

When the service user 101 clicks on the member button D202, the information indicative of the action will be entered (step S201) to connect to the representative server 301 (step S202). The representative server 301 in turn will generate a display screen for entering a member ID, and the corresponding password, as shown in FIG. 4 (step S203). The representative server 301 will send thus generated display screen information to the service user 101 (step S204). Then input fields for entering a member ID and the corresponding password D301 will be displayed as shown in FIG. 4 to the service user 101 (step S205). The service user 101 in reply will type his/her member ID and password in to the input field D302 and D303 for the ID and password respectively (step S206).

When a next button D304 for requesting the next action is clicked, the member ID and password entered will be sent to the representative server 301 (step S207). The representative server 301 in turn will search the member indicated by the ID from within the user records (step S208) to generate incentive information for members (step S209) and then to allocate the address of a member service server to the user (step S210). The representative server 301 will transmit the address information of the service server as well as the incentive information to the service user 101 (step S211).

Then, the service user 101 displays the incentive information on the display field D402 of an incentive display D401 shown in FIG. 5 (step S212). When the next button D403 for requesting the next action is clicked a menu display request will be sent to the representative server 301 (step S213), the representative server 301 in turn will generate a display information of the member service menu (step S214) and then will transmit the display information to the service user 101 (step S215).

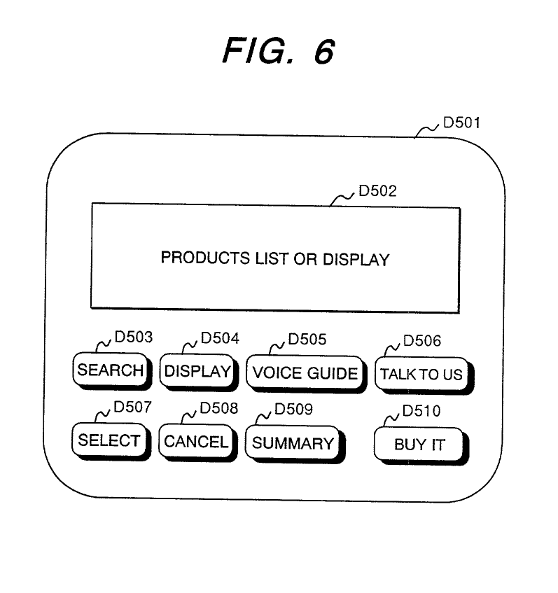

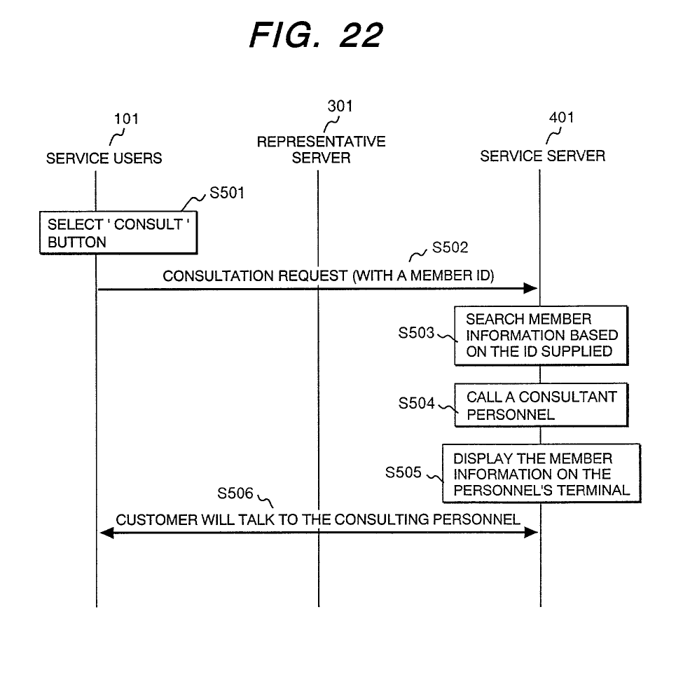

A menu display D501 shown in FIG. 6 will be displayed to the service user 101 on the basis of the display information (step S216). The service user 101 will send a service request to a service server 401 having the address of service server allocated in step S210 (step S218). The service request may be for example a product search request, a display request, a request of an audible product explanation, a request for a consultation about a product contents, a request for a selection of products, a cancel request of a selected item, a display request of total amount of charges of the selected items, a purchase order request and the like. One of the requests will be sent when clicking on a button of D503 to D510. Any commerce processing including such as the catalog search with respect to a service request, the purchase order processing, the settlement processing with a financial institution, the processing of shipping will be handled in the service server 401 (step S219), and the catalog information or search result of products will be in reply sent to the service user 101 (step S220). The replied information will be displayed on a display D502 for the service user 101 (step S221). When any further service request is desired, the procedure steps including the transmission of the service request (step S218), shopping transaction (step S219), transmission of reply information (step S220), and screen display (step S221) will be iteratively repeated as needed. The process when the consulting button D506 is clicked is shown in FIG. 22.

When the ‘talk to us’ button D506 is clicked (step S501), then the consulting request and the member ID will be sent to the service server 401 (step S502). The service server 401 will in turn search the information from the user records by using the member ID (step S503) in order to perform a smooth consultation by a consultant, then call a sales consultant (step S504), and display any necessary member information including the name, purchase records (dates and items of purchase) of the service user 101 on the terminal display of the consultant (step S505). Thereafter the user 101 will directly talk to the consultant (step S506) through a communication facility including a VOIP adapter.

(3) Service Provided for Guests

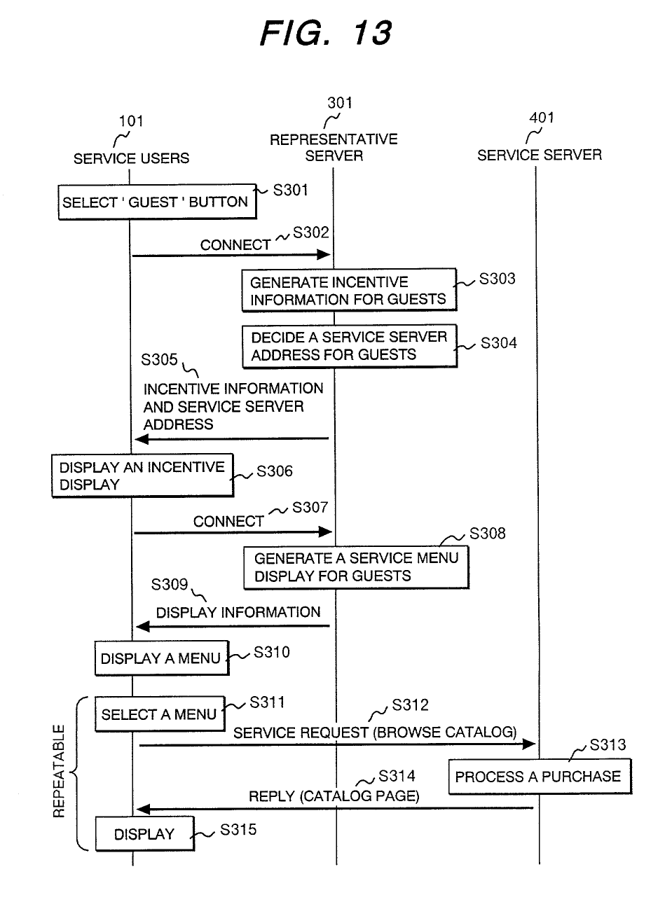

The flow of operation when the guest button D203 of the selecting option screen D201 is clicked will be described below by referring to FIG. 13.

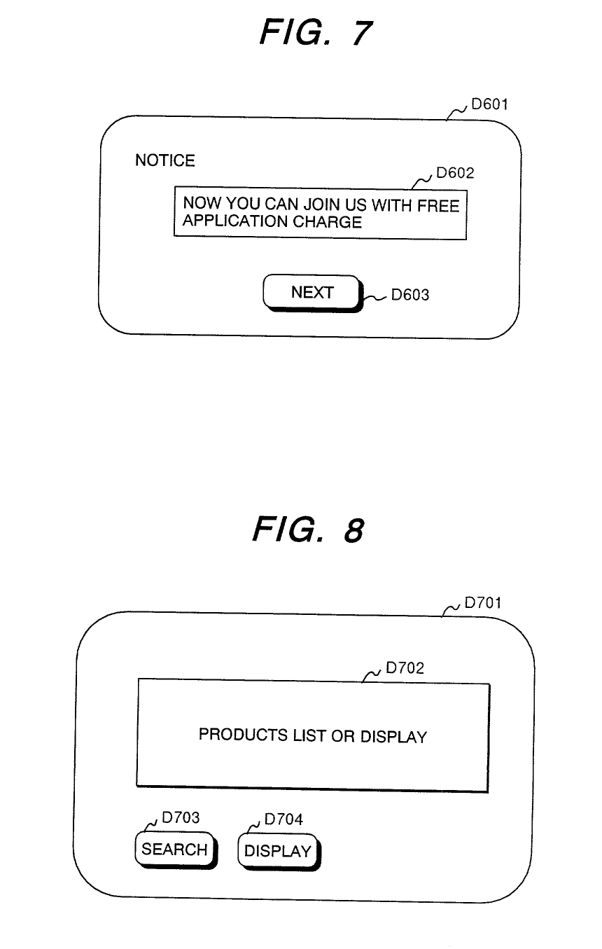

When the guest button D203 is clicked (step S301), the user will be connected to the representative server 301 (step S302). The representative server 301 then will generate an incentive information for guests (step S303), allocates the address of a service server for guests (step S304), and transmit to the service user 101 incentive information thus generated and the address of the service server allocated (step S305). The incentive information sent will be displayed, as shown in FIG. 7, on the display field D602 of the incentive display D601 for the service user 101 (step S306). Then the user will click the next button D603 for requesting the next action to send a menu display request to the representative server 301 (step S307), which in turn will generate a service menu display information for guests (step S308) to send to the service user 101 (step S309).

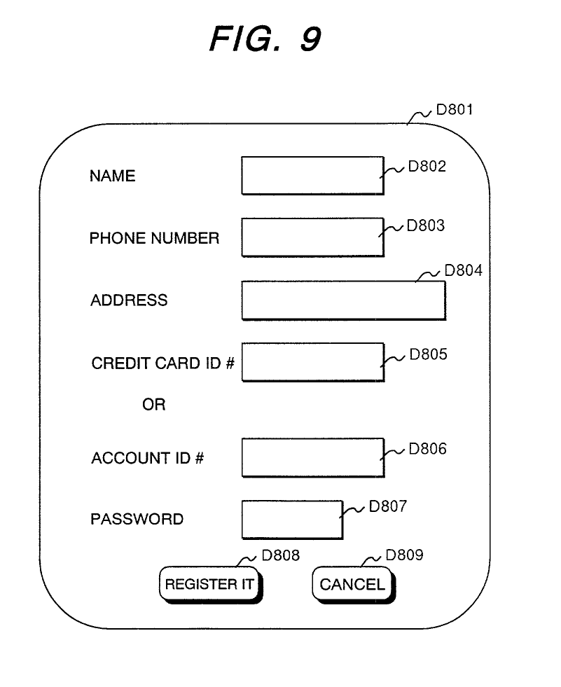

The menu display screen D701 shown in FIG. 8 will be displayed based on the display information sent to the service user 101 (step S310). Then the service user 101 will send a service request to the service server 401 having the service server address allocated in step S304 for the guests (step S312). The service request includes a search request of an item, display request and so on, one of these requests will be sent when clicking on a button of D703 to D704. Any service processing that is not related to a purchase order, such as a catalog search for an item requested by the service request will be processed in the service server 401 (step S313), the catalog information or search result of an item will be sent to the service user 101 in reply (step S314). Then the response will be displayed on the display screen D502 for the service user 101 (step S315). When any further service request is desired, then the transmission of a service request (step S311), a shopping transaction (step S313), transmission of reply information (step S314), and screen display (step S315) will be iteratively repeated as needed.

At this point, as another embodiment, a guest user may purchase any items if the user enters any credit card information necessary during the catalog browsing.

(4) Application of Joining from a Guest

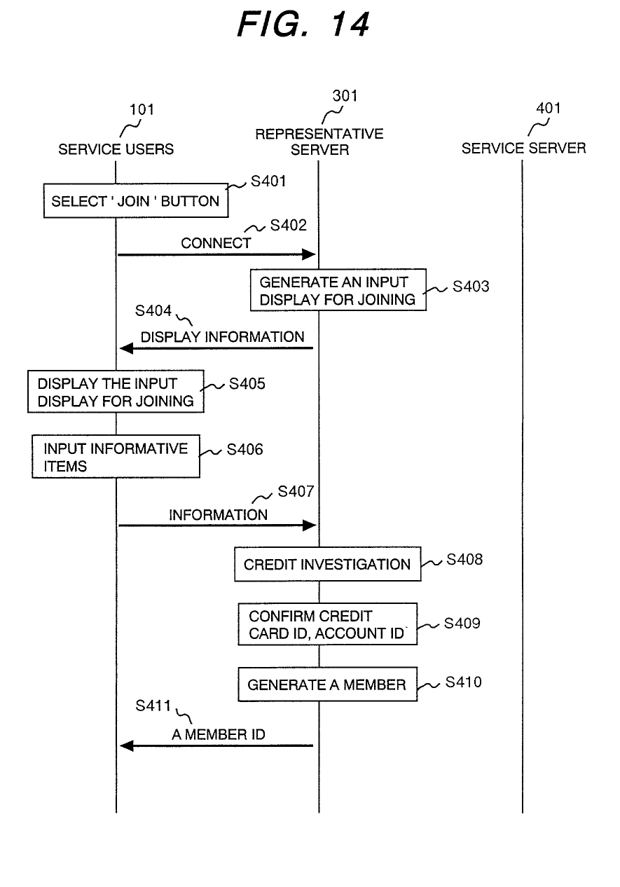

The flow of operation when the join button D204 is clicked in the option display D201 will be described below by referring to FIG. 14.

When clicking on the join button D204 (step S401), the service user 101 will be connected to the representative server 301 (step S402). The representative server 301 will generated the display information about the application of joining (step S403), then transmit thus generated display information to the service user 101 (step S404). Then, an input display D801 shown in FIG. 9 will be displayed to the service user 101 (step S405). The service user 101 will enter his/her name into the name field D802, phone number into the phone number field D803, postal address into the address field D804, credit card number into the card number field D805, bank account number into the account number field D806, and password into the password field D807 (step S406). When clicking on the register button D808 thereafter, the user input required for the registration will be sent to the representative server 301 (step S407). The representative server 301 will assess the credit information of the applicant (step S408), verify the bank account or credit card number and holder's name (step 409), and generate a membership ID (step S410) to send thus generated ID to the service user (step S411).

(5) Generation of Incentive Information and Address of a Service Server

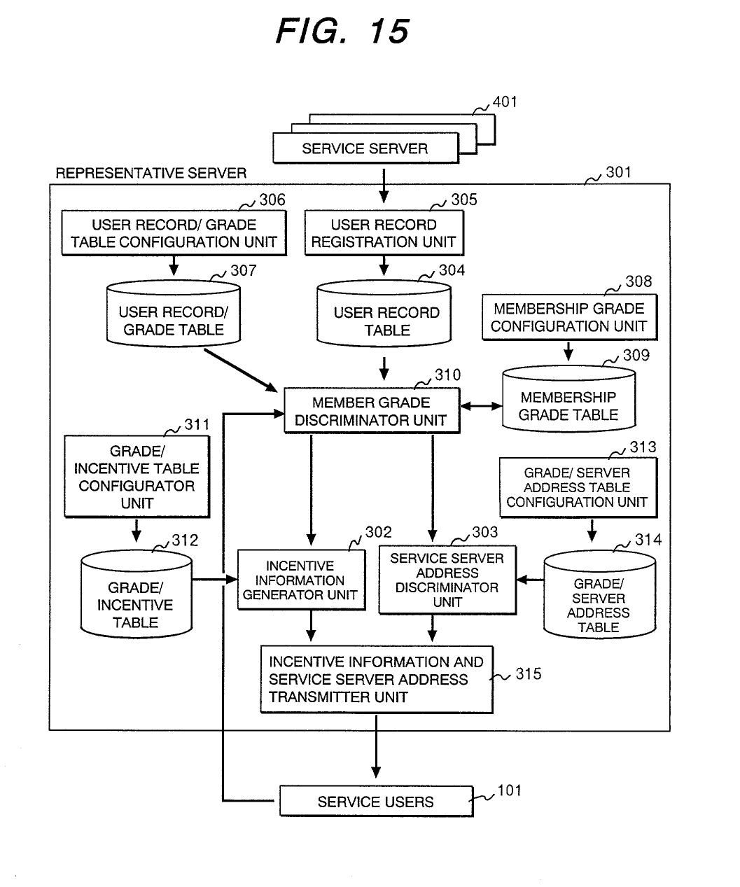

The flow of operation for generating incentive information and the address of a service server to be allocated in the representative server 301 is shown in FIG. 15.

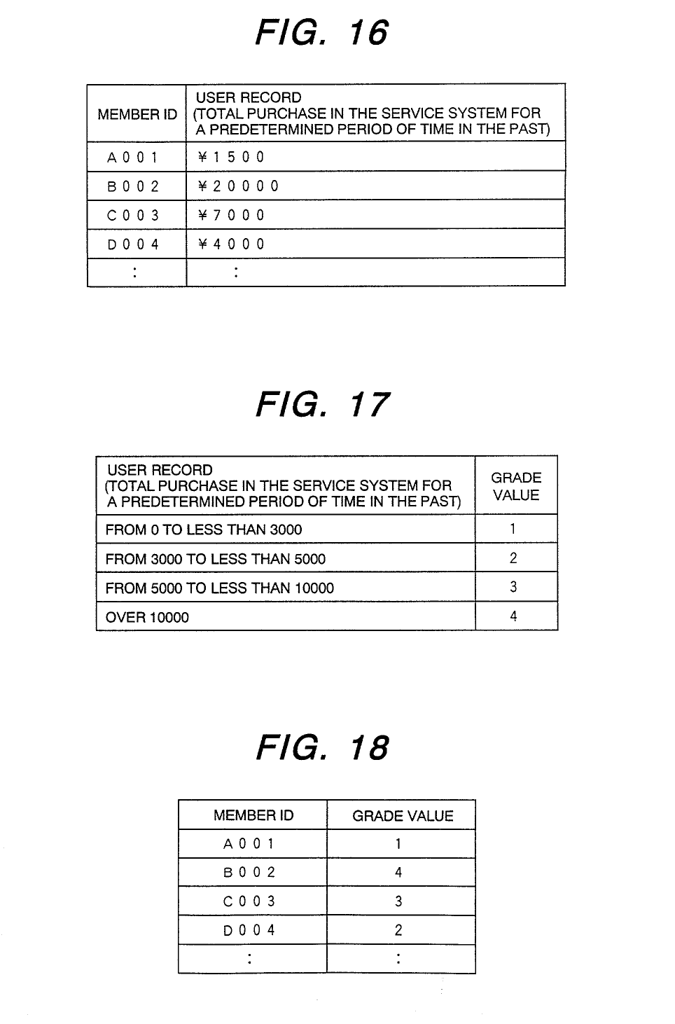

The representative server 301 uses the member ID sent from a service user 101 to search in the user record table 304 shown in FIG. 16 to retrieve the user's user record. The member grade discriminator unit 310 will use thus retrieved user record of the user as a key to seek the user record/grade table 307 shown in FIG. 17 to determine the user's grade value.

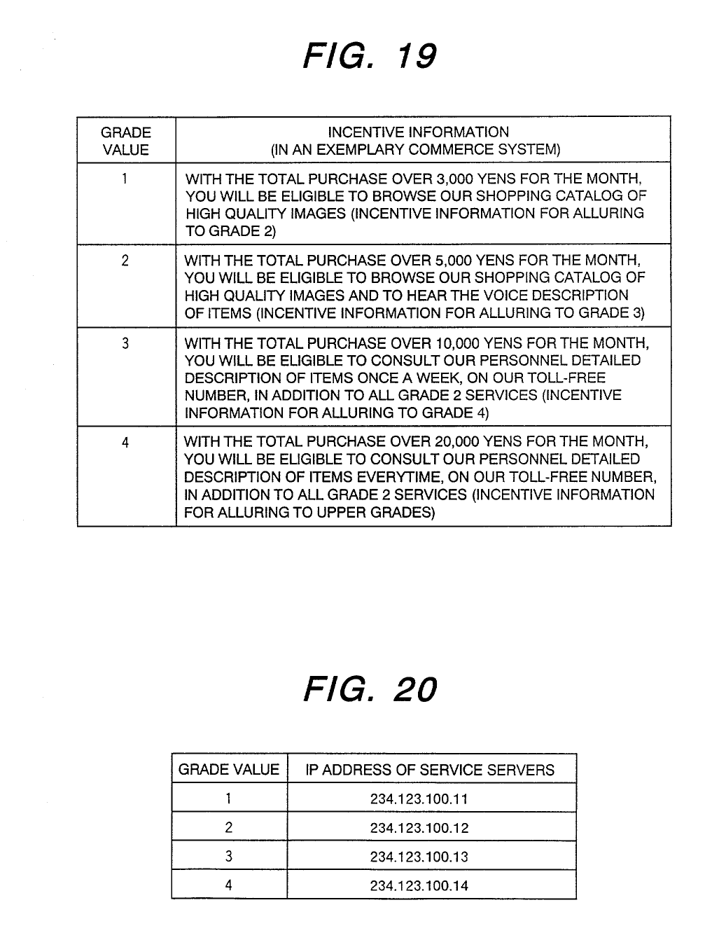

In addition, the member grade discriminator unit 310 will use thus determined grade value as a key to seek the user grade/incentive table 307 shown in FIG. 19 again to decide the incentive information to be sent to the user. In addition, the member grade discriminator unit 310 will use the grade value as a key to seek the grade/server address table 314 shown in FIG. 20 to determine the address of a service server. Thus determined incentive information and the address of a service server will be sent to the service user 101 through an incentive information and service server address transmitter unit 315.

A user record registration unit 305 will add any new records sent from the service server 401 to the user record table 304 to merge it.

The settings of the contents of the user record/grade table 307 can be done by the system administrator using the user record/grade table configuration unit 306.

In the foregoing description, a method for determining a member's grade in the member grade discriminator unit 310 by seeking the user record table 304 for each connection request of the service user 101 has been described. As an alternative, a membership grade table 309 may be used for determining and storing the grade of membership users in advance. For example, if user's purchase is not very often but is very important, the user's grade can be set accordingly regardless of the user's purchase record in the past. The membership grade configuration unit 308 can be used for this purpose.

The member grade discriminator unit 310 may also uses the user record table for determining the user's grade to store in the membership grade table 309, instead of seeking the user record table 304 each time the service user 101 connects thereto, or alternatively update the member grade table by determining the member's grade each time the service server 401 send thereto an additional purchase record.

(6) Selection of Service Servers by the Address Resolver

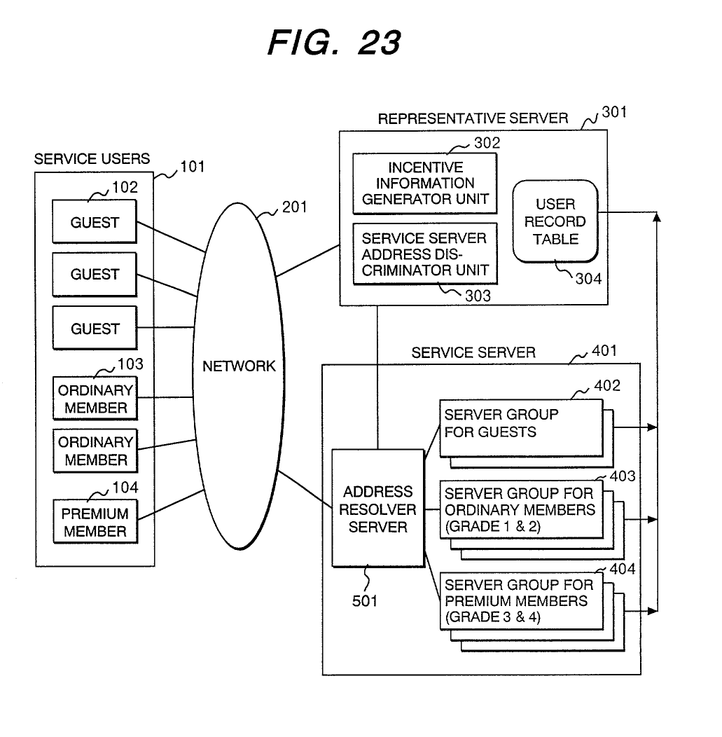

In the preferred embodiment shown in FIG. 1, a method is used in which the representative server 301 provides the address of a service server 401 to the service user 101 for the service user 101 to connect directly to the service server 401. However, in this method a service user may intentionally be able to directly connect to a given service server for ordinary users or premium users since the address of the service server 401 is noticed to the service user 101. In order to hide the address of the service server 401 from the users, an address resolver server 501 is provided between the service users 101 and the service server groups 402, 403 and 404 in the preferred embodiment shown in FIG. 23. By interposing an address resolver server 501 the connection status to the service server groups can be managed on the address resolver server 501, so as to facilitate the administration of entire server groups, to help to prevent the addresses of the service servers from being leaked outside as well as to select for a premium user a server to which fewer users are connecting, to limit the communication bandwidth of guests, and to monitor the quality of service (throughput, delay, etc.).

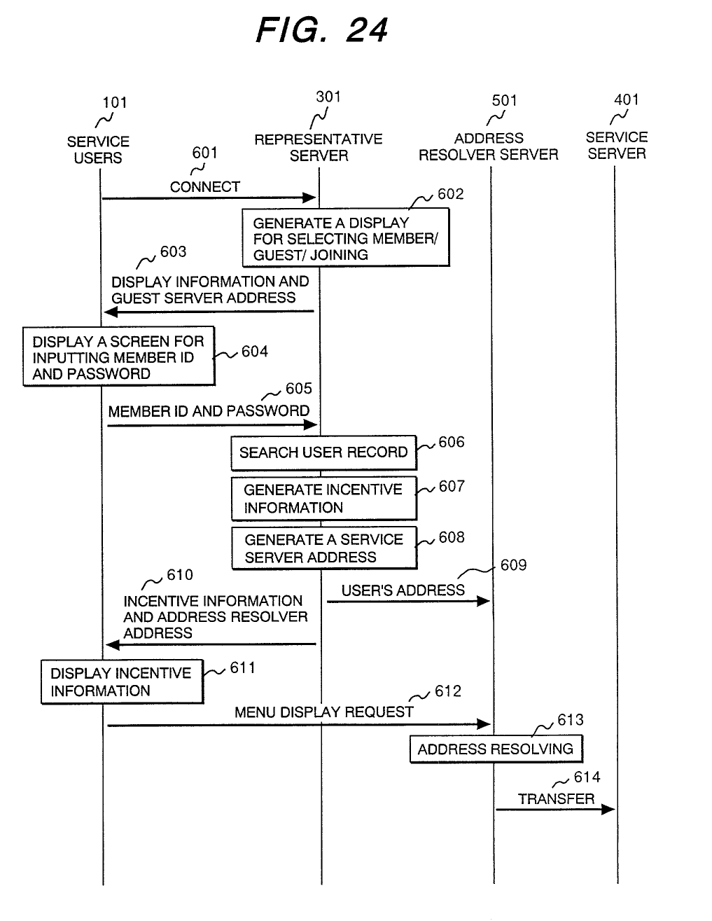

The flow of operation of the connection from the service user 101 through the address resolver server 501 to the service server 401 will be described below by referring to FIG. 24. A service user 101 will enter the address of representative server 301 to connect thereto (step S601). The representative server 301 will generate a selectable option display for the member/guest/joining (step S602) and reply the display information and the address of the server for members to the service user 101 (step S603). The option display screen D201 will be displayed to the service user 101 for selecting one of member/guest/joining as shown in FIG. 3 (step 604).

When clicking on the member button D202 of the selecting option screen D201, the service user 101 will enter his/her member ID and password to the input fields shown in FIG. 4 for entering a member ID and the corresponding password D301 to send the member ID and password to the representative server 301 (step S605). The representative server 301 upon reception will retrieve the user's purchase records based on the member ID (step S606), generate the incentive information for members (step S607), and allocate the address of a service server for members (step S608). The representative server 301 will send the address of the service server and the address of the service user to the address resolver server 501 (step S609) and will send the incentive information and the address of the address resolver server 501 to the service user 101 (step S610). The address of the address resolver server 501 is an address commonly shared by the service servers.

To the service user 101 the incentive information will be displayed in the display window D402 of the incentive display D401 shown in FIG. 5 (step S611). When the user clicks on the next button D403, then the menu display request will be sent to the address resolver server 501 (step S612). The address resolver server 501, upon reception of the request, will perform translation operation to resolve or translate the destination address of the request to the address of the service server 401 (step S613) and will transfer to the service server 401 (step S614).

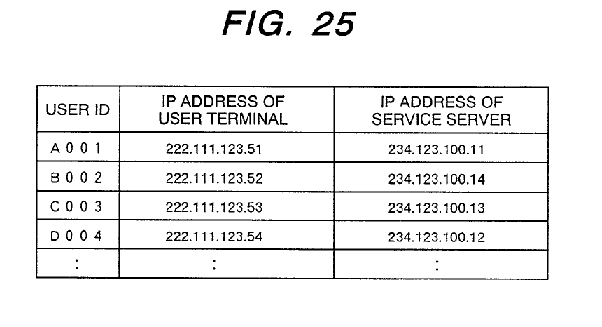

FIG. 25 shows a network address translation (NAT) table used for resolving the address. Pairs of service user addresses and service server addresses are stored in the NAT table.

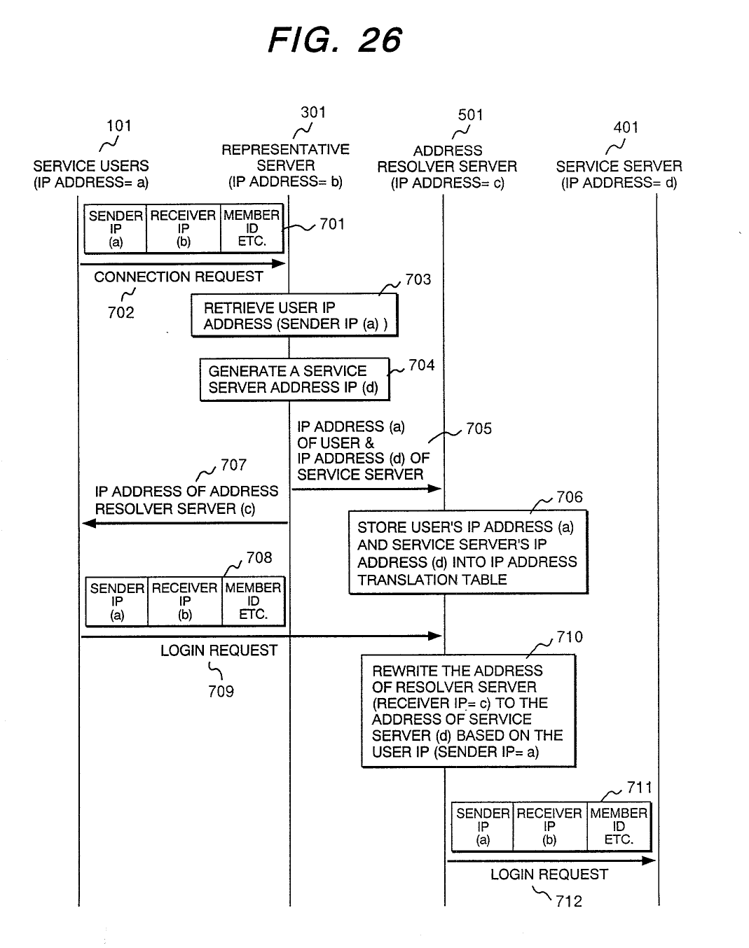

The processing of the request send from the service user 101 over the TCP/IP protocol used in the Internet to the service server 401 will be described by referring to FIG. 26.

The connection request sent from the service user 101 over the TCP/IP protocol will have the sender IP address (a) indicative of the address of the sending user, the destination IP address (b) indicative of the address of the destination representative server 301, and data section storing such information as member ID and the like. The connection request will be sent to the representative server 301 (step S702). The representative server 301 will pick up the user IP address (sender IP address (a)) (step S703). Then the representative server 301 will search the user from within the user records based on the member ID of the user and generate the IP address (d) of the service server 401 (step S704).

The representative server 301 will send the IP address (a) of the service user and the IP address (d) of the service server to the address resolver server 501 (step 704). The address resolver server 501 then will store the IP address (a) of the service user and the IP address (d) of the service server to the network address translation (NAT) table (step S705). The representative server 301 will send the IP address (c) of the address resolver to the user (step S707). The connection request from the service user 101 will be sent to the address resolver server 501 having the IP address (c) (step S709). The address resolver server 501 will use the network address translation table of FIG. 25 to translate the address (c) of the address resolver stored in the destination IP address section of the connection request into the address (d) of the service server used (step S710) to transfer the request to the service server 401 (step S712).

In FIG. 23 the address resolver server 501 is provided as one stand-alone server in the server groups, the NAT function can be incorporated in the representative server 301.

In the preferred embodiment in accordance with the present invention the addresses of the representative server and service servers in the shopping service system are represented by the IP addresses, however these addresses can be any other addresses indicative of the servers (for example, URLs of the WWW).

As can be appreciated from the foregoing description of the preferred embodiments in accordance with the present invention, an informative communication service system may be provided, which may be capable of improving the sales by selecting service users based on a criteria including the purchase record of the service users to allocate the service users to different, appropriate service servers so as to connect each user to a server preferable for increase of the sales profit.

The present invention may be embodied in other specific forms without departing from the spirit or essential characteristics thereof. For instance, in the electronic shopping system in accordance with the present invention, an informative communication service system may be provided, which may be capable of improving the sales by selecting service users based on a criteria including the purchase record of the service users to allocate the service users to different, appropriate service servers so as to connect each user to a server preferable for increase of the sales profit.

The foregoing description of the preferred embodiments of the invention has been presented solely for purposes of illustration and description thereof. It is to be noted that it is not intended to be exhaustive or to limit the invention to the precise forms disclosed, and numerous modifications and variations are possible in light of the above teachings or may be acquired from practice of the invention. The embodiments chosen and described in order to explain the principles of the invention and its practical application to enable one of those skilled in the art to utilize the invention in various embodiments and with various modifications as are suited to the particular use contemplated. it is also intended that the scope of the invention be defined by the claims appended hereto, and their equivalents.

What is claimed is:

1. A server assignment device, comprising:
a user record storage unit for storing user records of service in servers for each service users; and
a connecting unit for connecting one of a plurality of service servers selected in accordance with said user records of the service users upon reception of a connection request from the service users.

2. A server assignment device according to claim 1, wherein:
said connecting unit connects said service users to one of a plurality of service servers of different service contents or performance in correspondence with a grade determined based on said user records.

3. A server assignment device according to claim 1, wherein:
said connecting unit transmits the address of a selected service server to said service users.

4. A server assignment device according to claim 1, wherein:
said connecting unit transmits the address commonly shared by a plurality of said service servers to said service users, and translates said commonly shared address in a connection request from said service users to connect to the address of one of said plurality of service servers in correspondence with said user records of the service users.

5. A server assignment device according to claim 4, wherein:
said connecting unit provides with an address resolver server having said commonly shared address for translating the address of a connection request to the server to one of said plurality of service servers.

6. A server assignment device, comprising:
a user record storage unit for storing user records of services in servers for each of service users;
a server address discriminator unit for allocating the address of one of a plurality of service servers selected in accordance with said user records of the service users, upon reception of a connection request from said service users, to the address of a service servers to be connected.

7. A server assignment device according to claim 6, wherein:
said allocated address is transmitted to said service users.

8. A server assignment device according to claim 6, further comprising:
an address storage unit for storing the correspondence between the address of said service users and the address of said allocated service servers;
a transmitter unit for transmitting the commonly shared address of said plurality of service servers to said service users;
an address translation unit for resolving said allocated address in accordance with said address storage unit upon reception of a connection request from said service users to said commonly shared address in order to route said connection request to said service server having said address.

9. A server assignment device according to claim 8, further comprising:
an address resolver server including said address storage unit and said address translation unit.

10. A server assignment device according to claim 6, wherein:
said server address discriminator unit allocates one of a plurality of service servers of different service contents or performance in correspondence with the grade of said service users determined by said user records for the server to be connected.

11. A server assignment device according to claim 6, wherein:
said server address discriminator unit allocates one of a plurality of service servers of different number of limit of connected service users for the server to be connected, in accordance with the grade of said service users determined by said user records.

12. A server assignment device according to claim 10, further comprising:
an incentive generating unit for generating incentive information for offering incentive information to invite users to have more services provided, wherein:
said server assignment device transmits said incentive information generated by said incentive information generating unit to said service users.

13. A server assignment device according to claim 11, further comprising:
an incentive generating unit for generating incentive information for offering incentive information to invite users to have more services provided, wherein:
said server assignment device transmits said incentive information generated by said incentive information generator unit to said service users.

14. A server assignment device according to claim 12, wherein:
said incentive information is variable depending on the grade of said service users, and includes information about special offers for a specific grade or specific status of current user record of service users.

15. A server assignment device according to claim 13, wherein:
said incentive information is variable depending on the grade of said service users, and includes information about special offers for a specific grade or specific status of current user record of service users.

16. A server assignment device, comprising:
a membership grade configuration unit having grades of service users predetermined, indicative of the permission of connecting to one of a plurality of service servers of different service contents;
a server address discriminator unit for allocating one of a plurality of service servers selected in accordance with said grade of the service users upon reception of a connection request from said service users for the address of a service server to be connected.

17. A service providing system, comprising:
a plurality of service servers of different service contents or performance;
a representative server including:
a user record storage unit for storing user records of services in said service servers for each of service users,
a server address discriminator unit for allocating the address of one of said plurality of service servers selected in accordance with said user records of the service users, upon reception of a connection request from said service users, for the address of a service server to be connected, and
an incentive generating unit for generating incentive information for offering incentive information to invite users to have more services provided;
wherein:
said representative server transmits the address of thus allocated address of the service server and said incentive information to said service users;
said selected service server upon reception of a service request from said service users provides services.

18. A service providing system, comprising:
a plurality of service servers of different service contents or performance;
a representative server including:
a user record storage unit for storing user records of services in said service servers for each of service users,
a server address discriminator unit for allocating the address of one of said plurality of service servers selected in accordance with said user records of the service users, upon reception of a connection request from said service users, for the address of a service server to be connected, and
an incentive generating unit for generating incentive information for offering incentive information to invite users to have more services provided;
said representative server transmits a commonly shared address of said service servers and said incentive information to said service users;
said representative server further comprising:
an address storage unit for storing the correspondence between the address of said service users and the address of said allocated service servers; and
an address translation unit for resolving said allocated address in accordance with said address storage unit upon reception of a connection request from said service users to said commonly shared address in order to route said connection request to said service server having said translated address;
wherein:
said selected service server upon reception of a service request from said service users provides services.

19. A service providing system according to claim 18, further comprising:
an address resolver server interposed between said service users and service servers for storing said address storage unit and said address translating unit.

20. A service providing method, for use in a service providing system including a plurality of service servers of different service contents or performance and a representative server, comprising the steps of:
a first step of allocating an address of said service servers in correspondence with the user record of said service servers, upon reception of a connection request from said service servers to said representative server;
a second step of transmitting information for offering incentive to invite users to have more services provided; and
a third step of connecting said service users to said allocated service server.

21. A service providing method according to claim 20, wherein:
said third step of transmitting further includes a step of:
transmitting the address allocated in said first step of allocating to said service users.

22. A service providing method according to claim 20, wherein:
said third step of transmitting further includes the steps of:
transmitting an address commonly shared by said service servers to said service users; and
translating addresses from a service request with respect to said commonly shared address to a service request with respect to said allocated service server.
